(19) United States
(12) Patent Application Publication
(10) Pub. No.: US 2024/0316859 A1
(43) Pub. Date: Sep. 26, 2024

(54) METHOD OF ADDITIVE MANUFACTURE OF POROUS GAS-PERMEABLE SHAPED BODIES HAVING CONTROLLABLE POROSITY

(71) Applicant: RHEINISCH-WESTFÄLISCHE TECHNISCHE HOCHSCHULE (RWTH) AACHEN, Aachen (DE)

(72) Inventors: Patrick BONGARTZ, Aachen (DE); Moritz MEYER, Pullheim (DE); Matthias WESSLING, Aachen (DE); Alexander SCHEELE, Werl-Büderich (DE)

(73) Assignee: RHEINISCH-WESTFÄLISCHE TECHNISCHE HOCHSCHULE (RWTH) AACHEN, Aachen (DE)

(21) Appl. No.: 18/575,585

(22) PCT Filed: Jun. 30, 2022
(86) PCT No.: PCT/EP2022/068167

§ 371 Date: Dec. 29, 2023

(30) Foreign Application Priority Data
Jun. 30, 2021 (DE) 10 2021 116 862.7

(51) Int. Cl. B29C 64/153; B29C 64/268; B29K 77/00; B33Y 10/00; B33Y 70/00; B33Y 80/00

(52) U.S. Cl. CPC B29C 64/153; B29C 64/268; B29K 2077/00; B33Y 10/00; B33Y 70/00; B33Y 80/00

(57) ABSTRACT

A process for the additive manufacturing of porous gas-permeable shaped articles by selective laser sintering of a polymer powder may include
a) Providing a layer of polymer powder within an construction space;
b) Heating a polymer layer to a temperature greater than or equal to 0.5° C. and less than or equal to 2.5° C. below the melting point of the polymer powder;
c) Spatially resolved melting of a powder bed by means of the introduction of laser energy; wherein steps a-c) are carried out one or more times in the same construction space on consecutively superimposed powder layers and the surface energy contribution to be introduced in process step c) is greater than or equal to 1.7 times and less than or equal to 4.25 times the product of the melting enthalpy, polymer powder filling density and layer thickness of the powder filling.

The invention relates to a process for the additive manufacturing of porous gas-permeable shaped articles by selective laser sintering of a polymer powder comprising the steps of:
a) Providing a layer of polymer powder within an construction space;
b) Heating the polymer powder bed to a temperature greater than or equal to 0.5° C. and less than or equal to 2.5° C. below the melting point of the polymer powder;
c) Spatially resolved melting of a powder layer by means of laser energy input; wherein steps a-c) are carried out one or more times in the same construction space on consecutively superimposed powder layers and the surface energy contribution to be introduced in process step c) is greater than or equal to 1.7 times and less than or equal to 4.25 times the product of the melting enthalpy, polymer powder filling density and layer thickness of the powder filling. Furthermore, the invention relates to the use of the process for the production of filters and gassing and/or stirring devices as well as gassing shaped bodies as such.

The efficiency of continuously performed chemical reactions depends to a large extent on the reliable supply of the reactants required for the reaction. This general statement applies both to classic “chemical” reactions and to the biotechnological manufacture of products using biological organisms in bioreactors. The latter can pose a greater technical challenge under certain circumstances, as biological reactants generally react more sensitively to changing environmen-tal conditions than most chemical reactants. In order to supply the organisms during the course of the reaction, it is usually necessary to feed one or more process gases, which enables a constant and high efficiency over the entire conversion time. In practice, supplying sufficient quantities of process gas to the usually water-based process solutions is sufficiently difficult, as either an insufficient quantity is introduced as a function of the selected gassing method and device, or very large primary bubbles occur in the process liquid at high feed rates through the gassing unit. The latter contributes to an uneven distribution of the gases in the liquid and in some cases also to mechanical damage to the organisms. The entry is particularly complicated in cases where surface-active substances are present in the reactor or are formed during the reaction, as macroscopic foam is formed as a function of the selected agitator design, which prevents reproducible and efficient process control. In this respect, it would be desirable if flex-ibly designed and cost-effective gassing units could be provided, which enable a homogeneous and uniform bubble introduction with simultaneous homogeneous distribution of the bubbles in the process liquid, even with high gas flows. In addition, it would be advantageous if not only a constant process gas supply but also a convective distribution of the process gas in the entire liquid reactor volume could be achieved with little structural effort.

The patent literature also contains a wide variety of technical designs for supplying process liquids with process gases or for producing porous materials.

For example, WO 2019 126 602 A2 describes a composition for three-dimensional (3D) printing, a method for 3D printing and a resulting article having a porous structure. The composition comprises 50 to 100% by weight of a base polymer comprising a polyolefin (such as ultra-high molecular weight polyethylene), 0 to 50% by weight of an adhesive polymer (such as HDPE or PP); and optionally additives. The composition may be applied in a single layer, and the base polymer and the adhesive polymer each have a predetermined size or size distribution. The composition is sintered in a selected area to form a layer of a solid article having a predetermined pore size or pore size distribution. The predetermined particle size or size distribution for each of the base polymer and the adhesive polymer is determined by computer simulation based on the predetermined pore size or pore size distribution in the layer of the solid object. Furthermore, U.S. Pat. No. 2,008,277 837 A1 discloses gas permeable molds and mold segments with open porosity. Blind vents in the outer surface of the mold wall allow for an uninterrupted mold surface while enhancing the gas permeability provided by the open porosity. Methods of making such gas permeable molds include forming them from sintered material. The methods also include the use of solid freeform fabrication followed by sintering. Also disclosed are unitary structures for use in EPS bead molding comprising a vapor chamber portion having gas impermeable walls and a mold portion having a gas permeable mold wall with open porosity and optionally open and/or blind vents. Methods of manufacturing such unitary structures include the use of solid freeform manufacturing.

Furthermore, DE 10 2006 008 687 A1, for example, describes a method for gassing liquids, in particular in biotechnology and in particular cell cultures, with a gas exchange via one or more immersed membrane surfaces such as tubes, cylinders or modules, characterized in that this membrane surface performs any rotationally oscillating movement in the liquid.

Such solutions known from the state of the art can offer further potential for improvement. This relates in particular to the flexibility in the production of different geometries for combined gassing/agitation units and to the achievement of improved gas permeabilities while at the same time ensuring sufficient mechanical strength of the gas-liquid gassing shaped bodies as such.

It is therefore the task of the present invention to at least partially overcome the disadvantages known from the prior art. In particular, it is the task of the present invention to provide an additive manufacturing process which reproducibly achieves suitable porosities in gas-liquid gassing shaped articles. Furthermore, it is the task of the present invention to provide porous gas-permeable shaped bodies which can provide high reproducible gas flows with small primary bubble sizes in liquid media, irrespective of the geometry present.

The problem is solved in each case by the features of the independent claims, directed to the sintering process according to the invention, the use of the process according to the invention for the production of combined gassing and stirring devices for liquid reactors and the porous gas-permeable shaped bodies according to the invention, which are obtainable by the process according to the invention. Preferred embodiments of the invention are indicated in the dependent claims, in the description or in the figures, whereby further features described or shown in the dependent claims, in the description or in the figures may constitute an object of the invention individually or in any combination, as long as the context does not clearly indicate the contrary.

Accordingly, a process for the additive manufacturing of porous gas-permeable shaped articles by selective laser sintering of a polymer powder is according to the invention, which comprises the steps of:
a) Providing a layer of polymer powder within an construction space;
b) Heating the polymer powder bed to a temperature greater than or equal to 0.5° C. and less than or equal to 2.5° C. below the melting point of the polymer powder;
c) Spatially resolved melting of a powder layer by means of laser energy input; wherein steps a-c) are carried out one or more times in the same construction space on consecutively superimposed powder layers and the surface energy contribution to be introduced in process step c) is greater than or equal to 1.7 times and less than or equal to 4.25 times the product of melting enthalpy, polymer powder fill density and layer thickness of the powder bed.

Surprisingly, it was found that the additive process according to the invention can be used to produce highly porous shaped articles that exhibit significantly improved gas permeability compared to prior art solutions. In this respect, the shaped articles can exhibit improved properties, for example in the gas supply of liquid process media or in the area of filtering tasks. The method according to the invention can be used to provide a large number of different shaped article geometries in a highly flexible manner, whereby the shaped articles also have very good mechanical strength at high gas permeabilities. The latter properties can be used in particular to realize two different functionalities as part of a product design. For example, combined gas-sing and stirring units can be realized, which are able to provide large quantities of process gas per unit of time and also a homogeneous distribution of the process gases by means of suitable convection within the process liquids to be gassed. These advantages mean that, in gas-liquid reactors in particular, the process gas supply is no longer the very strongly limiting boundary condition for the progress of the reaction. What is surprising at this point is that the continuous porosity of laser-sintered shaped bodies, which is important for this application, is not a strict function of the amount of energy introduced. Without being bound by theory, it seems easy to understand that only incomplete sintering of the polymer powder occurs if the amount of energy is too small. This incomplete bonding of the individual polymer particles naturally leads to the formation of porous structures that are at least not completely sintered together. Surprisingly, however, it was found that high gas permeability via interconnected pores, i.e. porosity extending through the entire wall of the shaped article, is only achieved with higher irradiated laser energies. This desired continuous porosity is also not a linear function of the laser energy. In higher energy ranges, the ability of the shaped articles to achieve sufficient permeability de-creases again, although the porosity should increase again at higher energy levels due to the partial decomposition of the polymer material. In the very narrow energy range claimed according to the invention, higher porosities are thus obtained, extending through the entire shaped article, which either do not occur at all or only in reduced form in areas of lower or higher amounts of irradiated energy. The continuous porosity also has no negative effect on the mechanical properties, so that the shaped articles obtained by the process can be used very well in industrial stirring and gassing processes.

The process according to the invention is a process for the additive manufacturing of porous gas-permeable shaped articles by selective laser sintering of a polymer powder. The method according to the invention comprises the construction of coherent, porous structures via the sequential deposition and thermal joining of sintered powder layers. Additive manufacturing thus differs from conventional subtractive manufacturing processes, in which a shaped article is produced from a larger block by removing material. The structure of the entire shaped article is achieved by sequentially depositing layers of polymer powder, whereby the layers are applied one after the other to the already manufactured body and sintered or fused with the existing structure by applying energy using a laser. The polymer powder can consist of a wide variety of thermoplastic polymers, whereby either only one or a mixture of different polymer powders can be used. The polymer powder can have polymer powder particles of different sizes, whereby the powder particles preferably have a size of less than or equal to 100 μm, further preferably a size of less than or equal to 50 μm, further preferably less than or equal to 10 μm. The applied polymer layer is attached to the already sintered powder layers by means of energy input from a laser and this successive build-up also creates a porous shaped article structure in addition to the shaped article. The porous structure is particularly suitable for allowing gases to be transported from one side or surface of the shaped article to the other when excess gas pressure is applied. The gases are preferably transported across the shaped article through pores that span the shaped article, i.e. pores within the shaped article that extend continuously from one side of the shaped article surface to the other. Less preferred are isolated pores within the shaped article, which do not allow a continuous connection between the surface sides of the shaped article. These non-continuous pores only contribute to a very small extent to the mass transfer of process gases across the shaped article. At this point, the term “shaped article” means that the process is particularly suitable for forming structured and shaped bodies, at least in sections, whereby the surface area of the structures is significantly greater than the wall thickness of the shaped article. Suitable shaped article wall thicknesses are, for example, less than or equal to 10 mm, furthermore preferably less than or equal to 5 mm and furthermore preferably less than or equal to 2.5 mm. For example, a shaped article wall thickness can be 0.5 mm or 1 mm.

In process step a), a layer of polymer powder is provided within an construction space. The method according to the invention can be carried out using conventional laser sintering devices. In these conventional devices, a construction platform is provided within a temperature-controlled construction space, which can be moved variably in height. One or more layers of polymer powder can be applied to this construction platform by means of an application device. The thickness of the applied polymer powder can be variably adjusted, whereby preferably the powder layer thickness of an applied layer can be less than or equal to 1 mm, further preferably less than or equal to 0.5 mm and further preferably less than or equal to 0.25 mm. The applied polymer powder layer is then brought to a predetermined temperature in the installation space by means of an installation space heater, which can be controlled and displayed using thermo-couples or optical measuring methods, for example.

In process step b), the polymer powder is heated to a temperature of greater than or equal to 0.5° C. and less than or equal to 2.5° C. below the melting point of the polymer powder. For the adjustment of a specific porosity via the introduction of laser energy, it has proven to be particularly suitable that the polymer powder introduced into the construction space is pre-tempered to a very precise temperature difference in relation to the melting temperature of the polymer powder. This specified temperature range ensures that a very high proportion of the laser energy irradiation is used for actual melting and not just for tempering the polymer powder to the actual melting temperature of the polymer. Within this temperature range, there is a sufficiently large distance to the melting point of the polymer powder, so that unintentional melting of the polymer powder is also prevented by the temperature control of the construction space as such. The upper limit of the temperature distance to the melting point, on the other hand, is sufficiently small so that the energy for further heating of the polymer powder towards the melting point can be sufficiently neglected in comparison to the melting enthalpy of the polymer powder. It has also been shown within this specified temperature range that mixtures of differently aged polymer powder components can also be used safely and reproducibly.

In process step c), the powder layer is melted in a spatially resolved manner using laser energy. The individual polymer powder particles of the layer are melted by the localized irradiation of laser energy and then form a coherent layer area as a function of the thermal sintering process.

During this process, the individual powder particles of the newly applied powder layer and, if necessary, these are thermally bonded with other, already sintered components of the shaped part to be produced. In this way, almost any shape can be produced.

Process steps a-c) can be carried out once or several times in the same construction space on consecutively stacked powder layers. For the additive manufacturing of larger shaped parts, the depositing of the polymer powder and the layer-by-layer sintering of the powder layers can be carried out more frequently. As a function of the size of the entire shaped body, layer-by-layer sintering can be carried out more than 4 times, more than 10 times and more than 100 times, for example. The exact number of repetition steps is, among other things, a function of the applied powder layer thickness and the dimensions of the shaped part to be produced.

The surface energy contribution to be introduced in process step c) is greater than or equal to 1.7 times and less than or equal to 4.25 times the product of the melting enthalpy, polymer powder bulk density and layer thickness of the powder bulk. In order to produce shaped bodies with a high proportion of continuous pores that are particularly suitable for gas flushing purposes, it has been found to be particularly suitable that the laser energy used for the laser sintering process is within the range specified above. Mathematically, the laser energy to be applied according to the invention results from the amount of powder at the point to be sintered, i.e. from the product of the applied layer thickness and the powder density and the area of the point to be sintered. This amount of polymer powder must be melted using at least the amount of energy introduced by the laser. For this purpose, at least the melting enthalpy of the polymer powder must be applied. This narrow energy range to be irradiated is specified as a multiple of the melting enthalpy of the polymer powder used. The melting enthalpies of the different polymer powders are provided in the literature. If different melting enthalpy values are available in the literature, the melting enthalpy of the polymer powder under consideration can alterna-tively be determined experimentally using a DSC measurement. In this case, the melting enthalpy is determined in a second heating cycle at a heating rate of 10 K/min. If two or more polymers are used, the enthalpy of fusion is calculated mathematically from the melting enthalpy sum of the proportions of the individual polymer powders. In these cases, too, the melting enthalpy can be determined using a DSC measurement if there is any doubt. In cases where polymer powders are reused in different processes and repeatedly used in the installation space, it can usually be assumed that the melting enthalpy of the “old” polymer powder that has already been processed once, i.e. heated, differs only insignificantly from the melting enthalpy of the unused, new polymer powder.

In a preferred embodiment of the process, the polymer powder bed can be heated to a temperature of greater than or equal to 0.1° C. and less than or equal to 0.5° C. below the melting point of the polymer powder. In order to achieve the most reproducible porosity of the shaped articles, it has proven to be particularly suitable to bring the applied polymer powder layer as close as possible to the melting point of the polymer powder. In these cases, the laser energy applied later is essentially only used to melt the individual powder particles. This can both increase the processing speed during production and lead to a particularly suitable porosity of the laser-sintered parts.

In a further preferred embodiment of the process, the laser energy introduced in process step c) can be greater than or equal to 2.5 times and less than or equal to 3.5 times the product of the melting enthalpy, polymer powder bulk density and layer thickness of the powder bulk. For the additive construction of particularly suitable porous shaped articles with a high proportion of continuous pores through the shaped articles, the above-mentioned energy range to be applied has proven to be particularly suitable. Lower or higher energy levels can be disadvantageous, as the proportion of pores passing through the shaped articles can be significantly reduced in these. This means that there may be a maximum number of pores passing through the surface of the shaped articles within this range.

Within a further preferred aspect of the process, the layer thickness of the powder layer applied in process step a) can be greater than or equal to 0.075 mm and less than or equal to 0.25 mm. Within these thickness ranges of the applied powder layer, particularly homogeneous pore size distributions and a particularly high proportion of continuous pores within the shaped articles can be achieved in the energy range of the laser radiation according to the invention. Higher layer thicknesses can be disadvantageous, as the melting process of the polymer powder becomes too uneven in these. Smaller layer thicknesses can lead to the processing speed in additive manufacturing being too low.

According to a preferred characteristic of the process, the total layer thickness of the sintered porous gas-permeable shaped article can be greater than or equal to 2.5 times and less than or equal to 25 times the powder layer thickness provided in process step a) in each case. To obtain the most suitable pore size distribution with a high proportion of continuous shaped article wall pores, it has proven to be particularly advantageous that the applied powder layer thickness is selected in the above-mentioned relation to the total layer thickness of the shaped body. Within this range, a consistent pore structure can also be provided in the individual layer segments. In addition, sufficient mechanical strength of the entire shaped article can be provided within this range, which is particularly important in gassing and stirring applications in which the gassing unit is also used to introduce mechanical energy into a liquid.

In a further preferred embodiment of the process, the polymer powder used can comprise greater than or equal to 80 wt.-% and less than or equal to 100 wt.-% polyamide 12 (PA12). By means of the method according to the invention, polyamide 12 powders in particular can be processed into particularly suitable porous shaped articles. The shaped articles are characterized by a high porosity with a particularly high proportion of continuous pores and, in addition, the shaped articles are extremely mechanically stable even with very thin walls, so that these shaped articles can also be used in particular for stirring tasks in liquid reactors. A further advantage is that polyamide 12 powders can be reused to a high degree even after repeated use, so that the recycling rate for the production of the articles can be improved. For PA12 in particular, there is only a slight change in the thermodynamic properties that are important here as a function of repeated heating processes, so that the use of polyamide 12 also offers clear advantages in the industrial production of large gassing agitators.

Within a preferred aspect of the process, the powder may comprise a proportion of greater than or equal to 15 wt.-% and less than or equal to 100 wt.-% of new powder not yet used in a laser sintering process. In the context of the process according to the invention, it has been shown that the proportion of reusable polymer powder can be significantly increased without the desired convection/gas permeability properties being impaired. Within these proportions, mechanically very stable shaped articles can be produced, which provide continuously porous shaped articles with a suitable pore size distribution over the energy range irradiated according to the invention.

Furthermore, according to the invention, the process according to the invention can be used to manufacture devices selected from the group consisting of filters, gassing and/or stirring devices or combinations of at least two devices from this group. The process according to the invention is particularly suitable in the context of additive manufacturing processes which are aimed at the production of porous shaped bodies. The porous shaped bodies can be used for filtering purposes, for example. For example, the devices according to the invention can be used to provide filters that enable solid components to be separated from liquids. The water can be separated from the sample to be separated by means of the continuous pores in the shaped body, with the solids remaining on the large surface of the shaped body. A further use can be, for example, that the shaped bodies are used for gassing purposes in liquid reactors. The gassing devices can be used to reproducibly introduce process gases into liquids. This means that the liquid volume can be supplied with high quantities of gas components. Furthermore, based on the mechanical strength and the possibility of introducing gases into liquids through the shaped body, combined gassing and stirring devices can be produced, which can perform two separate tasks during use. On the one hand, for example, liquids can be supplied with process gases through the shaped body and, on the other hand, the gas can be distributed convectively in the liquid. It is also possible to consider applications in which a liquid is first supplied with process gas, this is then distributed convectively in the process liquid and, after completion of the desired reactions, the gassing and stirring unit is used as a filter.

In a further preferred embodiment of use, the device can be a gassing and stirring device, wherein the geometry of the gassing and stirring device is selected from the group consisting of spiral stirrer, inclined blade stirrer, paddle stirrer, disk stirrer, toothed disk stirrer, anchor stirrer, Rushton turbine or a combination of at least two geometries from this group. The process according to the invention has proven to be particularly suitable for manufacturing these types of stirrers. The stirrers are characterized by excellent strength and high gas permeability. This means that large volumes in liquid reactors can be supplied with sufficient process gases using relatively small stirrer structures. In addition, these stirrer geometries can generate particularly favorable convection so that the gas introduced can be evenly distributed throughout the reactor volume. The stirrer geometries can be easily scaled up to larger volumes and even difficult systems can be stirred and supplied with process gases. The latter applies, for example, to biological fermentation processes in which surface-active substances are produced or in which mechanically sensitive organisms are used as biocatalysts. These systems can be supplied with large quantities of process gases.

Further according to the invention, porous shaped bodies are produced by the process according to the invention, wherein the shaped bodies have an open porosity of greater than or equal to 14% by volume and less than or equal to 16% by volume. The method according to the invention can be used in particular to obtain porous shaped articles which have a particularly high proportion of open pores within the wall of the shaped body. This proportion of open pores also results, in particular, in many continuous shaped body pores, which enable a high convection of gases through the shaped body wall. This results in the lowest possible convection or transport resistance during the gassing of process liquids, which contributes to the fact that very high gas transfer rates can be provided through the walls of the shaped body. In principle, the proportion of open pores can be determined using porometry. The measuring principle of porometry is based on the fact that the pressure required to displace a liquid from a pore depends on its diameter. The relationship between the applied pressure and the pore diameter is established using the Young-Laplace equation. At the beginning of the measurement, the sample is immersed in a wetting liquid (Porefil) so that all open pores are completely wetted or filled. In the next step, the gas pressure in the sample is gradually increased. As the pressure increases, the open pores through which the gas can flow are freed from the wetting liquid from large to small and the sample gas (nitrogen) flows through them. At the same time, the flow rate through the pores is measured when the pressure is applied. By plotting the flow rate as a function of pressure, the so-called wet curve is obtained. A further measurement is then carried out in which the flow rate is measured through a dry, non-wetted sample. This gives the so-called dry curve. If the dry and wet curves are shown in a diagram, the diameter of the smallest and largest pore in the material can be determined. The so-called half-dry curve can also be calculated, whereby only half the flow rate of the dry curve is plotted as a function of the applied pressure. This allows an average pore size to be determined. The measurement can be carried out using a Porolux 1000 from Porometer, for example. By characterizing the pores using a capillary flow porometer, only the open pores through which flow can pass are taken into account. Furthermore, cylindrical straight pore channels (ideal pores) are assumed due to the use of the Young-Laplace equation. Furthermore, shaped bodies with a volume fraction of greater than or equal to 14.5% and less than or equal to 15.7%, and preferably greater than or equal to 15.0% and less than or equal to 15.5%, can be advantageous. Within these ranges, high gassing rates for liquid reactors can be provided with sufficient mechanical strength.

Also according to the invention are porous shaped bodies produced by selective laser sintering (SLS) for gas flushing or filtration of a process liquid, wherein the shaped bodies consist of greater than or equal to 75% by weight and less than or equal to 100% by weight of polyamide 12 and have an open porosity of greater than or equal to 14% by volume and less than or equal to 16% by volume. The method according to the invention can be used in particular to obtain porous shaped articles which have a particularly high proportion of open pores within the wall of the shaped body. This proportion of open pores also results, in particular, in many continuous shaped body pores, which enable a high convection of gases through the shaped body wall. This results in the lowest possible convection resistance during the gassing of process liquids, which contributes to the fact that very high gas transfer rates can be provided through the walls of the shaped body. In principle, the proportion of open pores can be determined using porometry. The measuring principle of porometry is based on the fact that the pressure required to displace a liquid from a pore depends on its diameter. The relationship between the applied pressure and the pore diameter is established using the Young-Laplace equation. At the beginning of the measurement, the sample is immersed in a wetting liquid (Porefil) so that all open pores are completely wetted or filled. In the next step, the gas pressure in the sample is gradually increased. As the pressure increases, the open pores through which the gas can flow are freed from the wetting liquid from large to small and the sample gas (nitrogen) flows through them. At the same time, the flow rate through the pores is measured when the pressure is applied. By plotting the flow rate as a function of pressure, the so-called wet curve is obtained. A further measurement is then carried out in which the flow rate is measured through a dry, non-wetted sample. This gives the so-called dry curve. If the dry and wet curves are shown in a diagram, the diameter of the smallest and largest pore in the material can be determined. The so-called half-dry curve can also be calculated, whereby only half the flow rate of the dry curve is plotted as a function of the applied pressure. This allows an average pore size to be determined. The measurement can be carried out using a Porolux 1000 from Porometer, for example. By characterizing the pores using a capillary flow porometer, only the open pores through which flow can pass are taken into account. Furthermore, cylindrical straight pore channels (ideal pores) are assumed due to the use of the Young-Laplace equation. Furthermore, shaped bodies with a volume fraction of greater than or equal to 14.5% and less than or equal to 15.7%, and preferably greater than or equal to 15.0% and less than or equal to 15.5%, can be advantageous. Within these ranges, high gassing rates for liquid reactors can be provided with sufficient mechanical strength.

In a further embodiment, the shaped article may consist of a thermoplastic polymer in a proportion by weight of greater than or equal to 75% by weight and less than or equal to 100% by weight, the thermoplastic polymer being selected from the group consisting of PA6, PA11, PA12, TPE, TPU, PP, PE, PS, PEEK, POM, PBT, PEO, PET, PGA, HDPE, LDPE, SAN, PMMA, their filled variants or mixtures of at least two components from this group. It has been shown for a large number of polymer powders that high porosity overall and a high proportion of continuous pores in particular can be provided by means of the energy density claimed according to the invention during the sintering process. In order to adapt the mechanical strength and to adapt to the respective gassing task, a preferred choice can be made from the above-mentioned group of thermoplastic polymers. In the filled variants of these polymer powders, in addition to the thermoplastic polymer as such, a high proportion of non-polymeric or non-thermoplastic polymeric fillers may also be present.

In a further embodiment, the shaped body can comprise a weight proportion of greater than or equal to 90 wt.-% and less than or equal to 100 wt.-% of polyamide 12. In particular, the shaped bodies made from polyamide 12 powders are suitable for the homogeneous supply of liquid or aqueous media with process gases. These high proportions of polyamide 12 powder can be used to provide combined gassing/agitating units that can also supply large filling volumes in reactors with sufficient quantities of process gas. The proportion of polyamide 12 powder can also preferably be greater than or equal to 95 wt.-% and less than or equal to 100 wt.-%, and furthermore greater than or equal to 98 wt.-% and less than or equal to 100 wt.-%.

According to a preferred characteristic, the shaped body can have an oxygen flow rate at a pressure difference of 500 mbar of greater than or equal to 2.0 L/min and less than or equal to 7.5 L/min. In particular, the shaped bodies according to the invention can provide a high amount of oxygen in process fluids. Without being bound by theory, this improved oxygen supply may be due in particular to the continuous pore structure and the actual pore size within the shaped bodies. In this respect, these shaped bodies may be suitable for simultaneous use as a gassing and stirring unit for liquid reactors. The oxygen flow rate through the shaped body wall can be determined on a 1 mm thick shaped body. The oxygen flow rate can be measured using capillary flow porometry/permeametry at 21° C.

In a further preferred embodiment of the shaped body, the shaped body can have pores of a size greater than or equal to 6.0 μm and less than or equal to 8.3 μm as determined by capillary flow porometry. Especially in these areas of the largest pores of the shaped body, particularly efficient shaped bodies for the gassing of liquids can result. The pores allow a very high flow of different process gases without reducing the mechanical strength of possible agitator designs. This results, for example, in mechanically sufficiently stable stirring or gassing units, which enable a sufficient and uniform supply of liquids of different viscosities with sufficiently small gas bubbles.

Further advantages and advantageous embodiments of the objects according to the invention are illustrated by the figures and explained in the following examples. It should be noted that the figures are descriptive only and are not intended to limit the invention in any way.

### Production of a Gas Flushing Shaped Article Using SLS:

Polyamide 12 (PA12 Smooth, refreshing ratio: 30% new powder, 70% old powder) was sintered with different surface energy inputs using a sinter laser printer. The layer height of the powder layers was 0.125 mm in each case and shaped articles with a total wall thickness of 1 mm were sintered.

Calculation of the laser energy that can be used according to the invention to achieve a surface energy density suitable for efficient gassing of a process liquid:

Polyamide 12 with an melting enthalpy of 95 J/g and a powder bulk density (δ) of 0.55 g/cm³ is used for the construction of gas flushing articles. This results in an amount of energy for the pure introduction of the melting enthalpy for the powder:

$$95 J / g \times 0.55 g / cm = 52.3 J / {cm}^{3}$$

The layer thickness (ε) of the applied powder layer is 0.0125 cm. In this respect, in order to introduce at least the melting enthalpy of this new powder volume element, a surface energy density of at least

$$52.3 J / {cm}^{3} \times 0.0125 cm = 0.65 J / {cm}^{3}$$

for melting the newly applied layer has to be introduced. Accordingly, the surface energy contribution to be applied according to the invention is at least 1.7 times (=1.105 J/cm²) to at most 4.25 times (=2.76 J/cm²), i.e. a range of

$$\geq 1.1 \; 05 J / {cm}^{2} up to \leq 2.76 J / {cm}^{2}$$

in which the advantageous porosity according to the invention is achieved with sufficient mechanical strength at the same time. Without being bound by theory, this energy surface input per volume element according to the invention means that the energy provided by the laser in this narrow range is only sufficient for specific, mechanically sufficient adhesion of the powder. Pore distributions are preferably produced which result in maximum gas permeability with a sufficiently small bubble size. If the construction space temperature is selected well outside the limits of greater than or equal to 0.5° C. and less than or equal to 2.5° C. below the melting point of the polymer powder, the additional energy contribution required to heat the powder to the specified range according to the invention must also be taken into account. The ranges of the laser energy to be applied to other powder deposits according to the invention result accordingly from the enthalpy of fusion, the bulk density and the thickness of the applied powder layer.

Different gassing shaped bodies, obtained by means of laser energy within the volume energy density range according to the invention, and two other shaped bodies, sintered below and above the energy density range according to the invention, were characterized using various test methods. The figures show

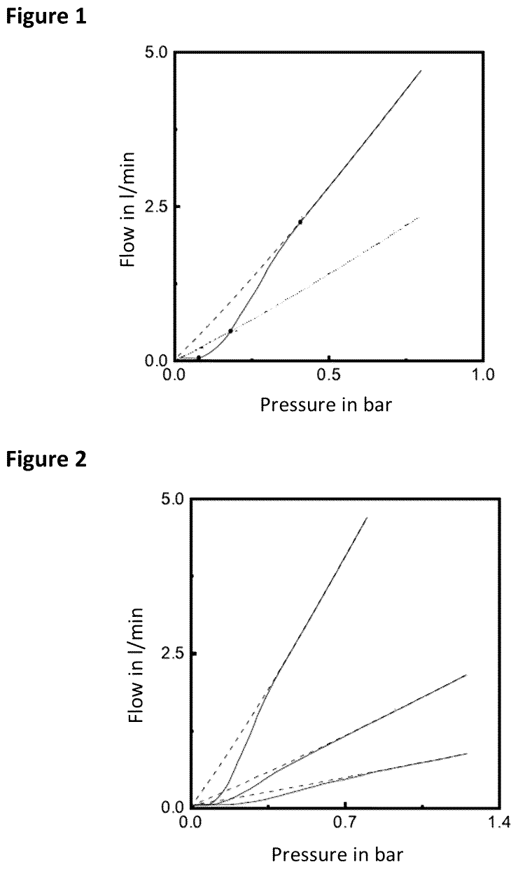

FIG. 1 the capillary flow porometry results of a shaped body laser-sintered in the surface energy range according to the invention;

FIG. 2 the dry and wet curves of the sintered gas flushed moldings with different surface energy inputs;

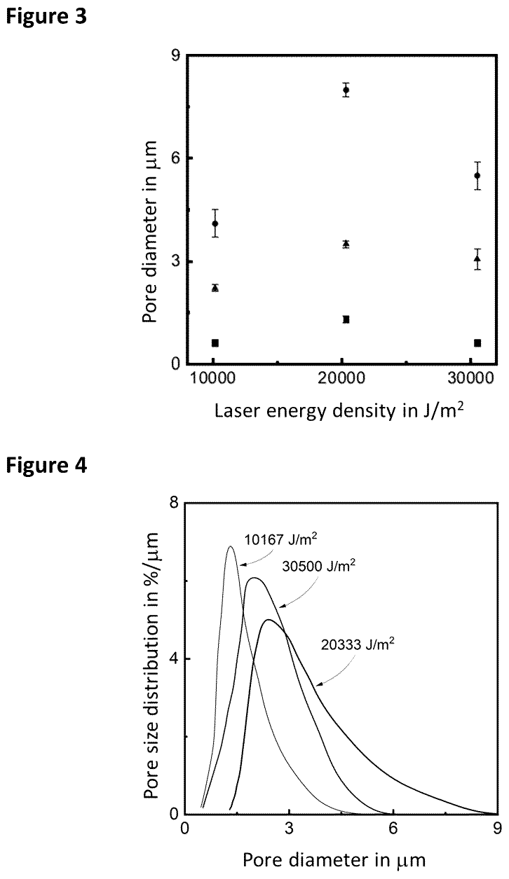

FIG. 3 the available pore diameters as a function of the surface energy input determined by capillary flow porometry;

FIG. 4 the pore size distributions of the gassing shaped parts printed with different laser energy densities;

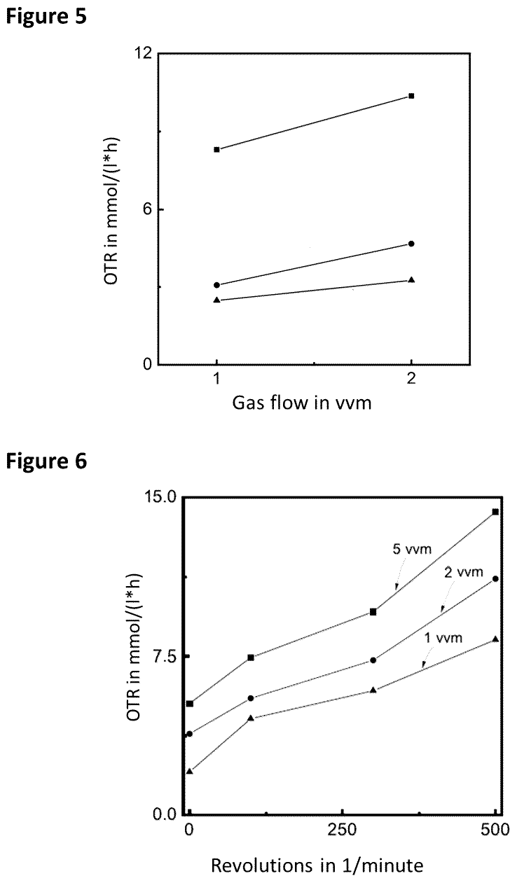

FIG. 5 the oxygen transfer rate through different types of gas flushing shaped bodies;

FIG. 6 the oxygen transfer rates of a spiral stirrer manufactured according to the invention as a function of the applied volume flow and the speed;

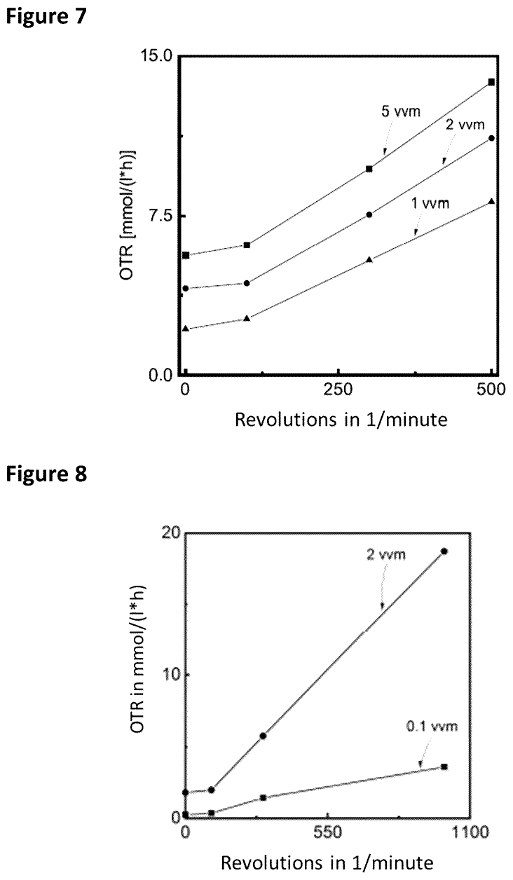

FIG. 7 the oxygen transfer rates of a Rushton turbine manufactured according to the invention as a function of the applied volume flow and the speed;

FIG. 8 the characteristics of a Rushton turbine not according to the invention;

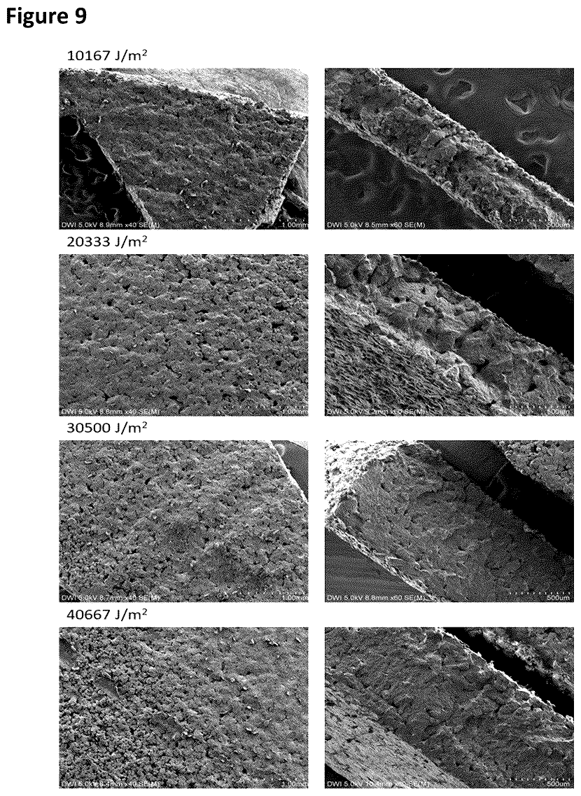

FIG. 9 Electron micrographs (FESEM) of the surface and cross-section of gassing shaped bodies produced with different laser energy densities;

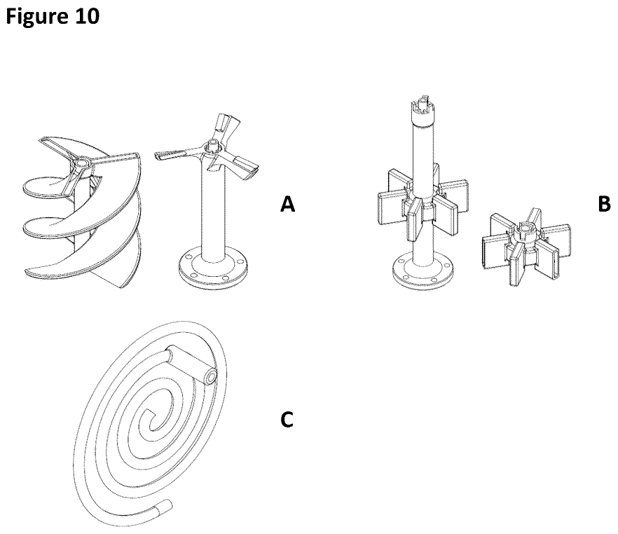

FIG. 10 in embodiments A-D, different stirrer geometries, which can be manufactured using the method according to the invention as an example.

FIG. 1 shows the capillary flow porometry results for a laser-sintered gassing shaped body with a surface energy of 2.0 J/cm². The porometry measurement principle is based on the fact that the pressure required to displace a liquid from a pore depends on its diameter. By comparing the gas flow through a dry sample and a sample wetted with Porefil, the pore size distribution and analytical values for the largest, smallest and average pore size of the material are obtained. This diagram shows the dry (dashed line), wet (solid line) and semi-dry (dotted line) curves. The smallest pore results from the intersection of the dry/wet curve and the average pore diameter from the intersection of the semi-dry/wet curve. The largest pore diameter results from the point of contact of the wet curve with the X-axis.

FIG. 2 shows the dry and wet curves of the gassing shaped bodies sintered with different surface energy inputs. The steepest curve was sintered with 2 J/cm² within the laser surface energy range used according to the invention. The dry and wet curves with the average slope were obtained from a shaped body sintered with 3 J/cm². The flattest curves represent the result for a sample sintered with 1 J/cm². It can be seen that the pore size distribution is not a linear function of the surface energy input of the laser.

FIG. 3 shows the results of the pore diameters as a function of the surface energy input determined using the capillary flow porometry curves shown in FIG. 2. This figure shows that outside the claimed surface energy input, less large pores are obtained with a similar mean pore diameter. The sample with a surface energy input of 2 J/cm² (20000 J/m²) shows significantly larger pores of approx. 8.3 μm than the comparison samples with 1 and 3 J/cm² (10000 and 30000 J/m²). The dimensions of the largest pores are approx. 50% below the largest pores of the shaped bodies according to the invention. The sample sintered in the stressed surface energy input range also shows the largest “smallest” diameters. This diameter distribution can contribute in particular to an increased diffusion/convection of process gases through the shaped body. It is surprising that there is no linear dependence as a function of the surface energy input, but that a parabolic curve with a maximum of the pore sizes in the stressed area is obtained.

FIG. 4 shows the pore size distributions of the gassing shaped bodies sintered with different laser energy densities. This diagram also shows that, surprisingly, no linear dependence of the pore size distribution on the surface energy density is obtained. The shaped body sintered in the energy range according to the invention shows the broadest pore size distribution with the largest pores. The largest “smallest” pores are also obtained in this sample. In contrast, the samples with higher and lower surface energy input each have smaller pores.

FIG. 5 shows the gas transfer rates through different types of gas flushing bodies. The top curve (squares) shows the dependence of the gas transfer rate for synthetic air as a function of the gas flow for a spiral sintered according to the invention. This geometry, together with the shaped body used according to the invention, shows the highest oxygen transfer rates. Compared to these transfer rates, the transfer rates of a ring gassing device (dots) and a sintered metal gassing shaped body (triangles) are lower by a factor of approx. 3. It can therefore be shown that the process according to the invention can be used to produce highly porous shaped bodies which, when used as gassing devices, for example in gas-liquid reactors, can contribute to a particularly efficient supply of process gases to the liquid in the reactor. In addition to pure gassing with process gases, the shaped bodies are also so stable that they are also suitable for generating convection in the liquid. For this purpose, the shaped bodies can be provided in the form of any stirrer geometry via the SLS process. The gas input normalized to the surface area of the geometries used is as follows for a gas flow of 1 vvm, for example:

| | | | Porous spiral |
|---|---|---|---|
| | Standard ring | Sintered metal | according to |
| | saver | saver | the invention |
| OTR (mmol/Lh) | 3.1 | 2.4 | 8.3 |
| Spec. OTR (mmol/Lhm)² | 240 | 1014 | 604 |
| Mass flow rate (mmol/h) | 15.3 | 12.2 | 41.7 |

It can be seen from the data that a gassing spiral according to the invention made of a material produced according to the invention can provide significantly higher material flow rates compared to the other two gassing devices.

FIG. 6 shows the oxygen transfer rates of a spiral stirrer manufactured according to the invention as a function of the applied volume flow and the rotational speed during gassing with synthetic air. OTR values in the range from 0.36 to 12.24 mmol/L*h can be achieved for a spiral stirrer designed as a gas flushing shaped body according to the invention. Gassing tests carried out with oxygen show that the OTR value can be increased by a maximum of 1030% and a minimum of 690% compared to synthetic air at a gassing rate of 2 vvm and speeds of 100, 300 and 500 rpm.

FIG. 7 shows the oxygen transfer rates of a Rushton turbine manufactured according to the invention as a function of the applied volume flow and the rotational speed. The Rushton turbine is the most widely used agitator geometry in biotechnology. With the porous Rushton turbine, OTR values in the range of 2.16 to 13.8 mmol/l*h could be measured. Here, the OTR value can be increased by a maximum of 840% and a minimum of 730% compared to synthetic air (39.36 to 93.19 mmol/l*h) by using oxygen as a gassing medium at a gassing rate of 2 vvm and speeds of 100, 300 and 500 rpm.

FIG. 8 shows the characteristics of traditional bubble gassing with a Rushton turbine not manufactured according to the invention. The traditionally manufactured turbines can only achieve transfer rates similar to those of the shaped bodies according to the invention at very high speeds. In the lower and medium speed range, there are clear advantages to using the gas-sing/agitating devices according to the invention. At a gassing rate of 2 vvm and a speed of 300 rpm, the stirrers produced using the method according to the invention can introduce 30% more process gas into the liquid. The OTR values determined at a speed of 100 rpm and a gassing rate of 2 vvm air in a 5 L bioreactor for the porous Rushton turbine and a spiral stirrer according to the invention are 120% (spiral stirrer) and 180% (Rushton turbine) higher than the values that can be achieved using traditional bubble gassing.

FIG. 9 shows an electron micrograph (FESEM) of the surface and cross-section of gassing shaped bodies produced with different laser energy densities. The energy density is indicated above the image in each case. The left-hand image shows an edge area and the right-hand image shows a cross-section. The images show that all samples have a porous structure. Most of the pore channels can be seen in the 20333 J/m² (2 J/cm²) sample. They are also interconnected and penetrate the sample completely in some cases. Without being bound by theory, this structure could be one of the reasons for the significantly higher gas permeability of the gassing shaped bodies produced according to the invention.

FIG. 10 shows in embodiments A-C different agitator geometries or static gassing units, which can be manufactured using the method according to the invention as an example. FIGS. 10 A-D show different agitator geometries that can be obtained very well using the method according to the invention. The mechanical strength of these combined stirrer/gassing units is highly sufficient for the stirring tasks under consideration and large quantities of process gas can be reproducibly and uniformly fed into gas-liquid reactors via the shaped bodies according to the invention, generating high convection flows.

1. A process for the additive manufacturing of porous gas-permeable shaped articles by selective laser sintering of a polymer powder comprising the steps of:
a) Providing a layer of polymer powder within a construction space;
b) Heating the polymer powder bed to a temperature greater than or equal to 0.5° C. and less than or equal to 2.5° C. below the melting point of the polymer powder;
c) Spatially resolved melting of a powder layer by means of laser energy;
wherein steps a-c) are carried out one or more times in the same construction space on consecutively superimposed powder layers;
characterized in that the surface energy contribution to be introduced in process step c) is greater than or equal to 1.7 times and less than or equal to 4.25 times the product of the melting enthalpy, polymer powder bulk density and layer thickness of the powder bed.

2. The process according to claim 1, wherein the heating of the polymer powder bed is carried out to a temperature of greater than or equal to 0.1° C. and less than or equal to 0.5° C. below the melting point of the polymer powder.

3. The process according to claim 1, wherein the laser energy introduced in process step c) is greater than or equal to 2.5 times and less than or equal to 3.5 times the product of the melting enthalpy, the polymer powder bulk density and the layer thickness of the powder bulk.

4. The process according to claim 1, wherein the layer thickness of the powder layer applied in method step a) is greater than or equal to 0.075 mm and less than or equal to 0.25 mm.

5. The process according to claim 1, wherein the total layer thickness of the sintered porous gas-permeable shaped article is greater than or equal to 2.5 times and less than or equal to 25 times the powder layer thickness provided in method step a), respectively.

6. The process according to claim 1, wherein the polymer powder used comprises greater than or equal to 80% by weight and less than or equal to 100% by weight polyamide 12 (PA12).

7. The process according to claim 6, wherein the powder consists of a proportion of greater than or equal to 15 wt.-% and less than or equal to 100 wt.-% of new powder not yet used in a laser sintering process.

8. The use of a process according to claim 1 for manufacturing devices selected from the group consisting of filters, gassing and/or stirring devices or combinations of at least two devices from this group.

9. The use according to claim 8, wherein the device is a gassing and stirring device, wherein the geometry of the gassing and stirring device is selected from the group consisting of spiral stirrer, inclined blade stirrer, paddle stirrer, disk stirrer, toothed disk stirrer, anchor stirrer, Rushton turbine or a combination of at least two geometries from this group.

10. A porous shaped body produced by selective laser sintering (SLS) for gas flushing or filtration of a process liquid, characterized in that the shaped body consists of greater than or equal to 75% by weight and less than or equal to 100% by weight of polyamide 12 and has an open porosity of greater than or equal to 14% by volume and less than or equal to 16% by volume.

11. The shaped body according to claim 10, wherein the shaped body comprises polyamide 12 in a weight proportion of greater than or equal to 90 wt.-% and less than or equal to 100 wt.-%.

12. The shaped body according to claim 10, wherein the shaped body has an oxygen flow rate at a pressure difference of 500 mbar of greater than or equal to 2.0 L/min and less than or equal to 7.5 L/min.

13. The shaped body according to claim 10, wherein the shaped body comprises pores of a size of greater than or equal to 6.0 μm and less than or equal to 8.3 μm determined by capillary flow porometry.
